(19) United States
(12) Patent Application Publication
(10) Pub. No.: US 2026/0031259 A1
(43) Pub. Date: Jan. 29, 2026

(54) METACONDUCTOR HETEROSTRUCTURES FOR ENHANCED SKIN EFFECT SUPPRESSION IN RF DEVICES

(71) Applicant: University of Florida Research Foundation, Inc., Gainesville, FL (US)

(72) Inventors: Yong Kyu Yoon, Gainesville, FL (US); Saeyeong Jeon, Gainesville, FL (US); Alexander Wilcher, Gainesville, FL (US)

(21) Appl. No.: 19/278,580

(22) Filed: Jul. 23, 2025

Related U.S. Application Data
(60) Provisional application No. 63/676,595, filed on Jul. 29, 2024.

(51) Int. Cl. H01F 1/147; H02J 50/10

(52) U.S. Cl. CPC H01F 1/14708; H02J 50/10

(57) ABSTRACT

One metaconductor heterostructure material of the present disclosure comprises a plurality of ferromagnetic metals within a layered design; and a non-ferromagnetic metal included within the layered design, wherein different ones of the plurality of ferromagnetic metals exhibit different ranges of negative permeability. The layered design can include varying thickness ratios of the ferromagnetic metals and/or varying thermal conductivities for the ferromagnetic metals.

### CROSS-REFERENCE TO RELATED APPLICATION

This application claims priority to co-pending U.S. provisional application entitled, “Metaconductor Heterostructures for Enhanced Skin Effect Suppression in RF Devices,” having application No. 63/676,595, filed Jul. 29, 2024, which is entirely incorporated herein by reference.

### STATEMENT REGARDING FEDERALLY SPONSORED RESEARCH OR DEVELOPMENT

This invention was made with government support under 2235978 awarded by the National Science Foundation. The government has certain rights in the invention

### BACKGROUND

The ever-increasing demand for high-speed data transmission and efficient wireless communication necessitates solutions to address the detrimental effects of the skin effect at high frequencies. This phenomenon disrupts current flow in conductors, causing it to concentrate near the surface and decay exponentially with depth. This leads to increased resistance and signal attenuation, ultimately hindering the performance of radio frequency (RF) devices.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows skin depth of copper at various frequencies of an alternating current (AC) current in accordance with the present disclosure.

FIG. 2 provides a schematic illustration of the skin effect on a wire in accordance with the present disclosure.

FIG. 3 depicts the effectiveness of metaconductors in canceling eddy currents induced by an AC current versus normal conductors.

FIG. 4A is a drawing of a ternary asymmetric metaconductor structure with three distinct metal layers in accordance with various embodiments of the present disclosure.

FIG. 4B is a drawing of a quaternary asymmetric metaconductor structure with four distinct metal layers in accordance with various embodiments of the present disclosure.

FIG. 4C is a drawing of a higher-order asymmetric metaconductor structure with five distinct metal layers in accordance with various embodiments of the present disclosure.

FIG. 5A presents a schematic drawing of gradient metaconductor heterostructures having a fixed thickness of the ferromagnetic metal with varying thickness of the non-ferromagnetic metal in accordance with various embodiments of the present disclosure.

FIG. 5B presents a schematic drawing of gradient metaconductor heterostructures having a fixed thickness of the non-ferromagnetic metal with varying thickness of the ferromagnetic metal in accordance with various embodiments of the present disclosure.

FIG. 6 shows a block diagram of a radiative wireless power transfer (WPT) system in accordance with the various embodiments of the present disclosure.

### DETAILED DESCRIPTION

The present disclosure presents a novel class of metaconductors termed metaconductor heterostructures. These structures overcome the limitations of conventional binary metaconductors by incorporating more than two ferromagnetic metals within their layered design. This strategic approach offers significant advantages in mitigating the skin effect at high frequencies, thereby leading to improved performance in radio frequency (RF) devices.

Conventional materials like copper (Cu) struggle to overcome the limitations imposed by the skin effect at high frequencies. Metaconductors, with their alternating layers of non-magnetic and ferromagnetic metals, have emerged as a promising solution. However, current research primarily focuses on binary metaconductor structures, which might exhibit limitations in frequency response as binary structures are effective only within a specific frequency range, limiting their applicability; thermal stability as certain binary metaconductor materials might not offer sufficient thermal stability for high-power RF applications; and optimization potential as restricting the design to binary structures may limit the potential for further optimization of loss reduction efficiency.

The present disclosure addresses the limitations of binary metaconductors by introducing metaconductor heterostructures. These structures incorporate more than two ferromagnetic metals within their layered design, enabling significant advancements in skin effect suppression.

The skin effect is a phenomenon in which high frequency alternating current (AC) flows primarily on the surface of a conductor, rather than uniformly throughout the cross-section. This is caused by the changing magnetic field created by the signal, which induces eddy currents in the conductor that generate their own magnetic field. The interaction of these fields causes the signal to be confined to the outer layer of the conductor. The skin effect results in increased RF resistance, leading to power loss, heat generation, and decreased RF performance in high frequency applications. As a result, the signal and power integrity can be deteriorated. The skin depth is defined as the depth of the skin effect and can be calculated using the formula:

$$δ ( skin depth ) = \sqrt{\frac{2 ρ}{ω μ}} = \sqrt{\frac{1}{π f {μ}_{eff} σ}} \qquad ( 1 )$$

where σ is the electrical conductivity, μ is the magnetic permeability of the conductor, f is the operational frequency, ρ is the resistivity of the conductor, ω is the angular operational frequency of the current, μ_{eff} is the effective magnetic permeability of the conductor, and σ is the average electrical conductivity.

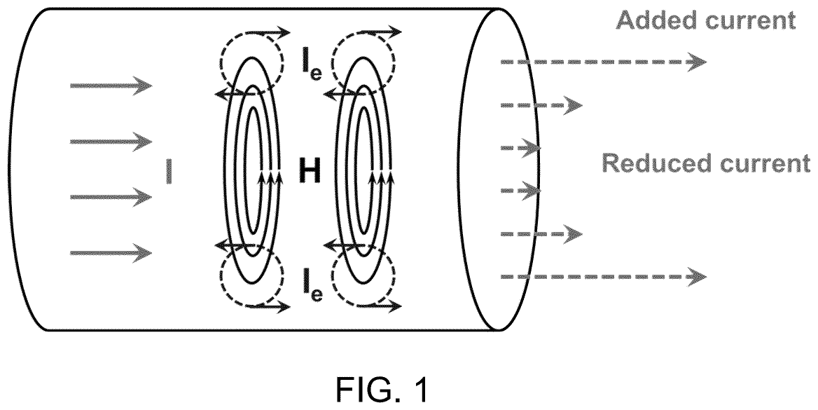

As the frequency of the AC current increases, the skin depth decreases. At high frequencies, the AC current may be confined to a very thin layer of the conductor's surface. Accordingly, FIG. 1 shows the calculated skin depth as a function of the operating frequency. The calculated Cu skin depths are 9,220 μm, 2.06 μm, and 0.206 μm for operation frequencies of 50 Hz, 1 GHZ, and 100 GHz, respectively. The skin depth decreases exponentially, which exacerbates the skin effect at higher frequencies. While there are several approaches to minimize the effects of the skin effect, such as using stranded wires, tubular conductors, or a higher conductivity material, these methods are not quite effective at high frequencies.

The skin effect can have a number of significant effects in high-frequency applications. For example, the skin effect can increase the resistance of a conductor, which can lead to power losses. Skin effect can also cause non-uniform current distribution, which can lead to overheating and mechanical stress. At high frequencies, the skin depth is inversely proportional to the square root of the frequency. This means that as the frequency doubles, the skin depth is halved. Additionally, the skin effect is more pronounced in good conductors, such as copper and silver.

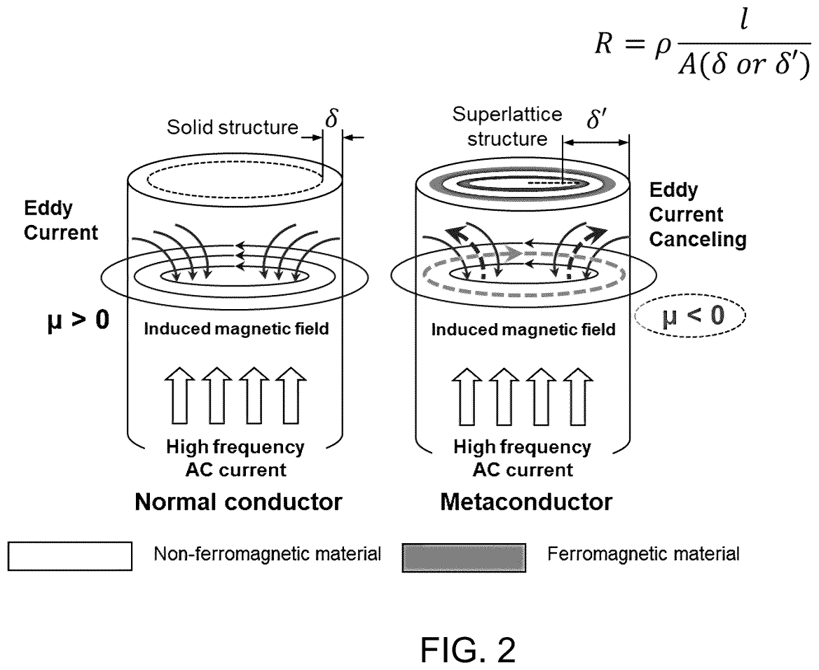

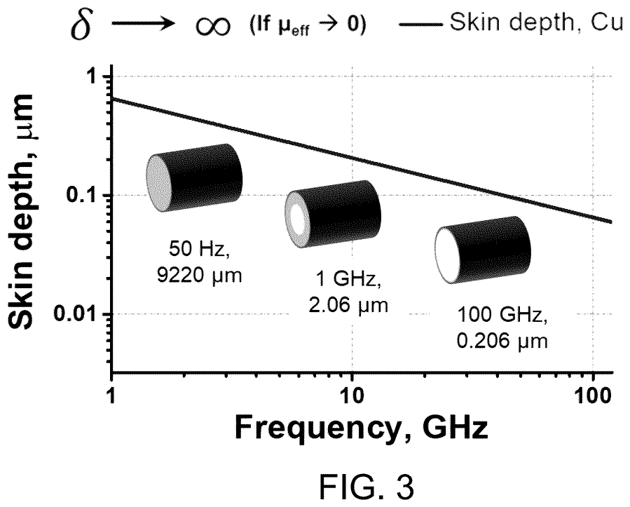

FIG. 2 shows a schematic illustrating the skin effect on a wire with FIG. 3 depicting the effectiveness of metaconductors in canceling eddy currents induced by AC current versus normal conductors. At high frequency, AC current flowing through the normal conductor (positive permeability) induces a magnetic field that rotates counter-clockwise. This magnetic field, in turn, induces eddy currents within the conductor. These eddy currents flow in the opposite direction to the applied current, particularly concentrated in the center of the conductor. This phenomenon effectively reduces the usable cross-sectional area for current flow. The decreased cross-sectional area leads to increased RF resistance and, consequently, higher losses in the conductor. Correspondingly, metaconductors (having negative permeability engineered at a target frequency) offer a solution to the limitations of normal conductors at high frequencies. These engineered materials exhibit negative permeability at a specific target frequency. When an AC current flows through a metaconductor at this target frequency, the AC current still induces a magnetic field. However, the negative permeability of the metaconductor causes this magnetic field to be opposite in direction to what occurs in a normal conductor. This opposing magnetic field then induces eddy currents that flow in the same direction as the applied current. This phenomenon effectively cancels out the eddy currents induced by the skin effect, leading to a larger usable cross-sectional area for current flow. The increased cross-sectional area translates to decreased RF resistance and significantly reduced losses in the metaconductor compared to a normal conductor.

By using the combination of non-magnetic and ferromagnetic layers, the positive permeability of the non-magnetic materials (μ_{N}) cancels out the negative permeability of the ferromagnetic materials (μ_{F}) between ferromagnetic resonance (FMR) and anti-ferromagnetic resonance (AFMR) frequencies achieving eddy current cancellation, thereby setting the effective permeability of the metaconductor zero. The effective magnetic permeability [symbol] (μ [symbol] _{eff}) of such a multilayer stack-up is given by Eq. 2:

$${μ}_{eff} = \frac{{μ}_{N} {t}_{N} + {μ}_{F} {t}_{F}}{{t}_{N} + {t}_{F}} \qquad ( 2 )$$

where t_{N} and t_{F} are the thickness of the non-ferromagnetic and ferromagnetic layer, respectively, and μ_{N} and μ_{F} are the magnetic permeability of the non-ferromagnetic (close to 1) and ferromagnetic layer, respectively. From Eq. 2, μ_{eff} for the metaconductor becomes zero when:

$${μ}_{F} = \vert \frac{{t}_{N}}{{t}_{F}} \vert \qquad ( 3 )$$

Thus, an infinite skin depth on the metaconductor can be theoretically achieved by substituting μ_{eff}=0 to the skin depth equation (δ). Therefore, the important parameters are the thickness ratio of t_{N}/t_{F} and the negative permeability, up, values of ferromagnetic materials, where ty/tr refers to the ratio of the thickness of the non-ferromagnetic layer (t_{N}) to the thickness of the ferromagnetic layer (t_{F}) in the metaconductor. This ratio plays a crucial role in determining the overall effective permeability of the composite material. Additionally, the permeability value (μ_{F}) of the chosen ferromagnetic material significantly impacts the performance of the metaconductor. Different ferromagnetic materials exhibit varying ranges of negative permeability. Optimizing the selection and thickness ratio of these materials is key to achieving the desired reduction in skin depth. Thus, by carefully selecting materials and tailoring layer thicknesses, metaconductor heterostructures can target a wider range of frequencies, achieving effective skin effect suppression across a broader spectrum. This enhances their applicability in various RF applications.

For example, utilizing materials with high Curie temperatures within the heterostructure significantly improves its thermal stability. This makes the heterostructure suitable for high-power RF applications where heat dissipation is critical. Thus, by incorporating multiple ferromagnetic metals with different thermal conductivities within the metaconductor heterostructure, the overall heat dissipation can be improved. This can be achieved by strategically placing materials with higher thermal conductivity in regions where heat generation is more significant.

Additionally, exploring various material combinations and optimizing interfaces between layers allows for fine-tuning the current flow and potentially achieving even greater suppression of the skin effect. This translates to lower RF losses and improved device efficiency. Accordingly, the combination of multiple ferromagnetic metals allows for tailoring the magnetic response of the metaconductor. This can lead to a design that optimizes the negative permeability at the target frequency while maintaining good thermal stability, since some ferromagnetic materials exhibit superior thermal stability compared to others.

To illustrate, let's consider a specific example: a metaconductor heterostructure composed of Nickel (Ni) and Cobalt (Co). Here, Ni offers certain advantages (targeting low frequency), but its Curie temperature is lower compared to Cobalt (Co). This means it loses its ferromagnetic properties at a lower temperature, whereas Cobalt Co exhibits a stronger negative permeability than Ni at certain frequencies and boasts a higher Curie temperature, making it more thermally stable. Thus, by strategically combining Ni and Co in a layered heterostructure design, we can potentially achieve the following benefits: (a) The Co layer with its higher Curie temperature can provide the necessary thermal stability for the overall metaconductor; and (b) the Ni layer can potentially contribute to lowering the target operating frequency of the metaconductor.

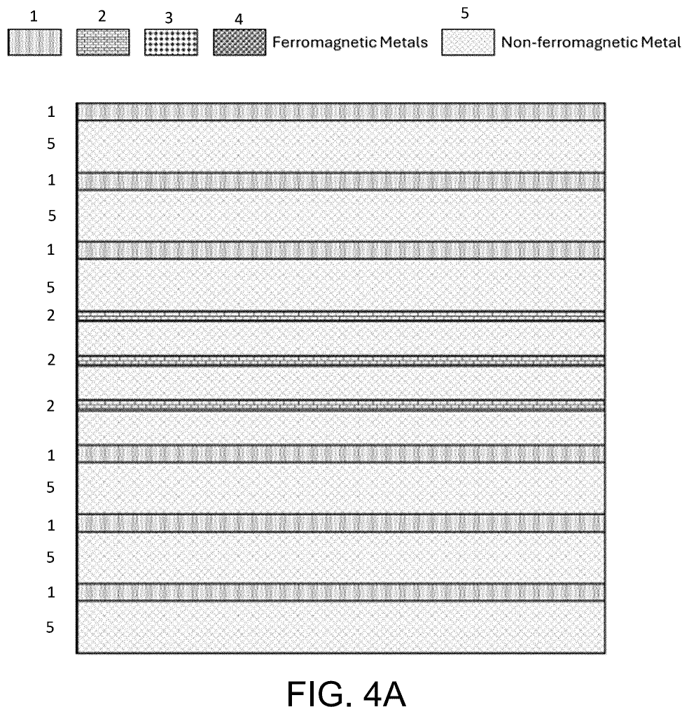

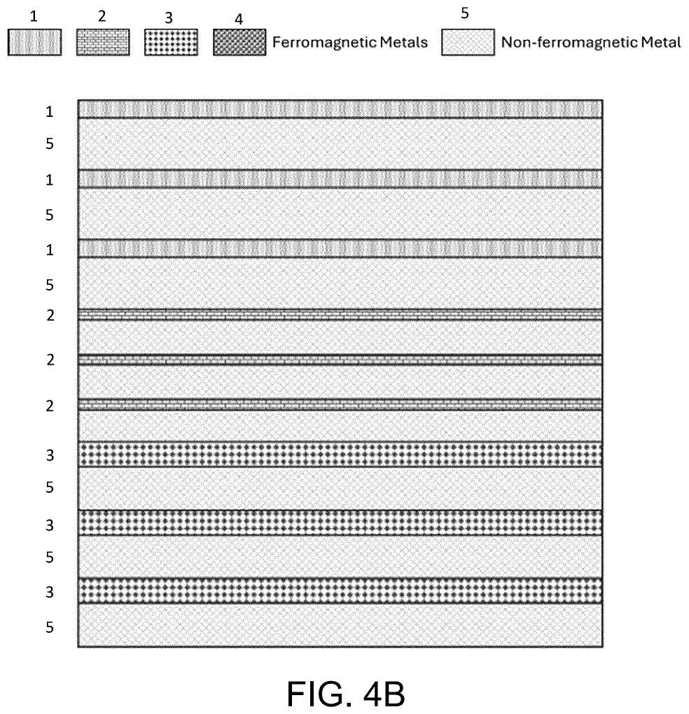

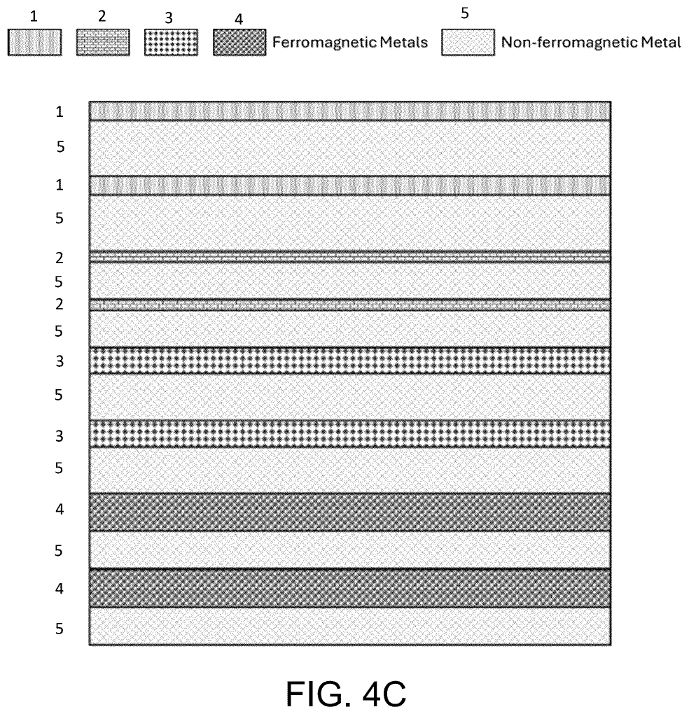

While specific metal choices can be optimized for particular applications, general configurations are provided to illustrate the concepts. Consider that an exemplary heterostructure can combine a base conductor with good overall conductivity (e.g., Cu) with ferromagnetic metals known for loss reduction (e.g., Ni and NiFe) and materials for enhanced thermal stability (e.g., Co) or higher operation frequency (e.g., Fe). Also, rare earth ferromagnetic materials such as Dysprosium (Dy), Gadolinium (Gd) (in alloys, e.g., GdFe), Samarium (Sm) (in alloys, e.g., SmCo5), and Holmium (Ho) can be potential candidates for metaconductor heterostructures in broader applications. An exemplary design can also incorporate additional layers of metals and potentially influence the current flow profile within the structure, leading to optimized performance. Further, it may be optimal for certain applications to utilize an asymmetric metaconductor having repeating specific bilayers, trilayers, or more layers within the structure. Asymmetric metaconductor examples include a ternary metaconductor structure having 3 different metals, as illustrated by FIG. 4A, such as one non-ferromagnetic metal and two ferromagnetic metals; a quaternary metaconductor structure having 4 different metals, as illustrated by FIG. 4B, such as one non-ferromagnetic metal and three ferromagnetic metals; and higher-order metaconductor structures (Quinary, Hexa, Septa, or more) structures that incorporate an increasing number of metals (5, 6, 7, or more), as illustrated by FIG. 4C (having 5 distinct metal layers).

Beyond material selection and geometric variations of exemplary metaconductor heterostructures, additional optimization of performance can involve layer thickness, material combinations, and interface engineering. For example, precise control over the thickness of each layer allows for targeting specific frequency ranges for optimal loss reduction. By carefully calculating and controlling layer thickness, the optimal loss reduction at the target frequencies can be achieved. Also, gradual changes in the thickness of a specific layer can create a gradient in material properties. This gradient can lead to a broader frequency response where the metaconductor heterostructure remains effective across a wider range of frequencies. Additionally, a tailored gradient can be designed to influence the current flow profile within the structure, potentially leading to more optimized performance for specific applications.

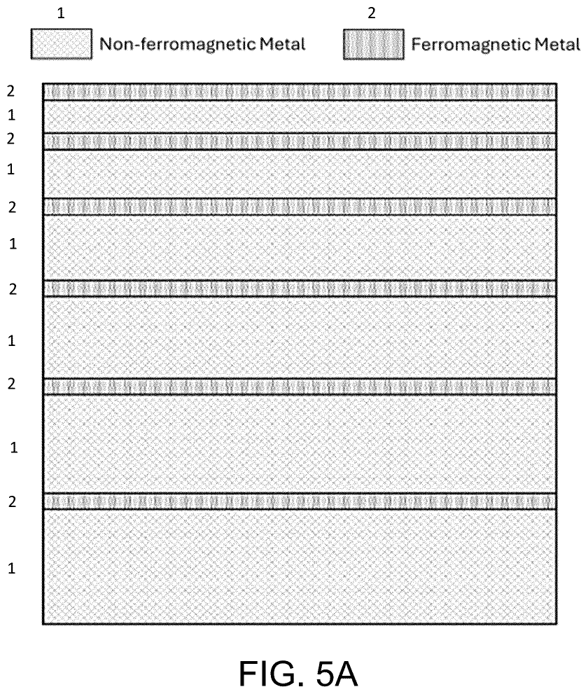

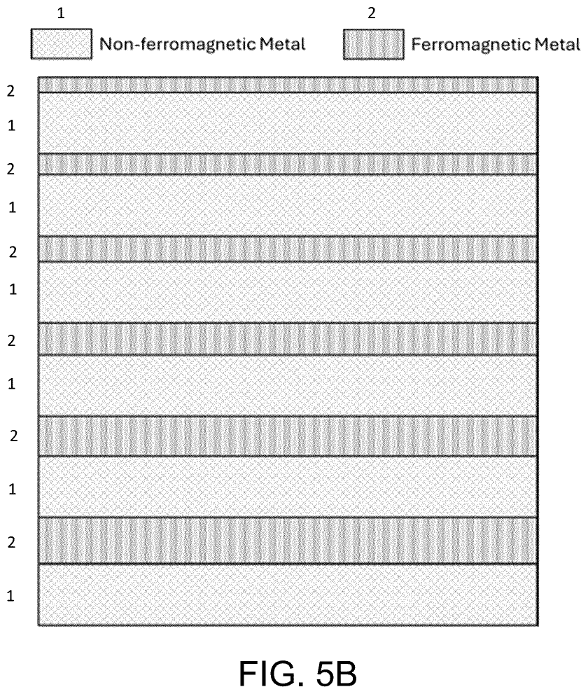

Accordingly, FIG. 5A presents a schematic drawing of gradient metaconductor heterostructures having a fixed thickness of the ferromagnetic metal with varying thickness of the non-ferromagnetic metal; FIG. 5B presents a schematic drawing of gradient metaconductor heterostructures having a fixed thickness of the non-ferromagnetic metal with varying thickness of the ferromagnetic metal.

With respect to material combinations, utilizing different metals with complementary properties can lead to synergistic effects, further enhancing overall performance, and for interface engineering, optimizing the interfaces between different layers minimizes losses due to scattering and resistance at the junctions, promoting efficient current flow across the entire structure. Techniques like ALD (Atomic Layer Deposition), sputtering, and surface treatments (e.g., annealing) can be used to achieve optimal interfaces.

Thus, the incorporation of metaconductor heterostructures in RF devices offers significant advantages, such as, but not limited to, faster data transmission speeds, improved power efficiency of RF systems, and minimized signal degradation. With respect to faster data transmission speeds, novel structures of the present disclosure minimize signal loss within interconnects, enabling significantly faster data transmission at high frequencies. This translates to quicker data transfer rates for various applications. For example, when the AC signal frequency increases, the skin effect becomes more pronounced. This phenomenon causes the alternating current to concentrate on the conductor's outer surface, leading to higher ohmic losses. Traditional copper conductors suffer from this effect, where a portion of the signal energy is converted into heat due to electrical resistance. Metaconductors, however, minimize the skin effect. This translates to lower electrical resistance, allowing more of the signal energy to be transmitted, ultimately leading to faster data rates.

Regarding improved power efficiency of RF Systems, by minimizing the skin effect, metaconductor heterostructures reduce losses throughout the RF system. This leads to improved overall power efficiency, resulting in lower power consumption for battery-powered devices and reduced heat generation in high-power applications compared to those using traditional copper conductors, which translates to longer battery life for portable devices and improved thermal management for high-performance systems. Accordingly, due to the reduced ohmic losses in metaconductors, less energy is wasted as heat.

Regarding minimized signal degradation, in high-frequency integrated circuits, minimizing signal degradation is crucial for optimal performance in areas like high-speed computing advanced wireless communication systems. Metaconductor heterostructures effectively mitigate the skin effect, thereby minimizing signal degradation and enhancing overall circuit performance. In other words, the optimized current distribution in metaconductors minimizes signal attenuation, which is the weakening of the signal strength as it travels through the conductor. This allows the signal to travel farther with less degradation, improving transmission quality and range. By spreading the current more uniformly throughout the conductor's cross-section, the interaction between the signal and the conductor material is reduced. This interaction can weaken the signal strength, so minimizing it through optimized current distribution helps maintain signal integrity.

Therefore, metaconductor heterostructures offer a revolutionary approach to tackling the skin effect challenge. By exploring diverse material combinations, optimizing layer configurations, and focusing on interface engineering, these structures have the potential to revolutionize the performance of RF devices, pushing the boundaries of high-frequency data transmission and wireless communication while also improving the overall power efficiency of RF systems.

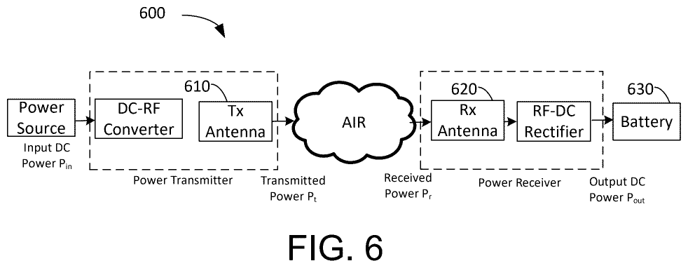

As a non-limiting example, FIG. 6 shows a block diagram of an exemplary RF system 600 (e.g., radiative wireless power transfer (WPT) system). Radiative power emitted from a Tx antenna 610 propagates through the air over a far distance and is captured by an Rx antenna 620 and then converted to DC power and stored to a battery 630. In various embodiments, the Tx and Rx antennas, feeding lines, and rectifier lines can be fabricated using metaconductor heterostructures in accordance with various embodiments of the present disclosure (e.g., on a low loss glass substrate).

It should be emphasized that the disclosed embodiments are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y.’”

We claim:

1. A metaconductor heterostructure material comprising:
a plurality of ferromagnetic metals within a layered design; and
a non-ferromagnetic metal included within the layered design;
wherein different ones of the plurality of ferromagnetic metals exhibit different ranges of negative permeability.

2. The metaconductor heterostructure material of claim 1, wherein the layered design includes varying thickness ratios of the ferromagnetic metals.

3. The metaconductor heterostructure material of claim 1, wherein the layered design includes varying thermal conductivities for the ferromagnetic metals.

4. The metaconductor heterostructure material of claim 1, wherein the plurality of ferromagnetic metals comprise Nickel and Cobalt.

5. The metaconductor heterostructure material of claim 1, wherein the plurality of ferromagnetic metals comprise Nickel and Cobalt and the non-ferromagnetic material comprises Copper.

6. The metaconductor heterostructure material of claim 1, wherein the plurality of ferromagnetic metals comprise Nickel-Iron (NiFe) and Cobalt and the non-ferromagnetic material comprises Copper.

7. The metaconductor heterostructure material of claim 1, wherein the plurality of ferromagnetic metals comprise Nickel and Iron.

8. The metaconductor heterostructure material of claim 1, wherein the plurality of ferromagnetic metals comprise Nickel and Iron and the non-ferromagnetic material comprises Copper.

9. The metaconductor heterostructure material of claim 1, wherein the plurality of ferromagnetic metals comprise Nickel-Iron (NiFe) and Iron and the non-ferromagnetic material comprises Copper.

10. The metaconductor heterostructure material of claim 1, wherein the plurality of ferromagnetic metals comprise three or more of Nickle, Nickle-Iron, Cobalt, Iron, Dysprosium, Gadolinium, Gadolinium-Iron (GdFe), Samarium, Samarium-Cobalt (SmCo5), and Holmium.

11. The metaconductor heterostructure material of claim 1, wherein the layered design comprises an asymmetric structural arrangement having a ternary metaconductor structure consisting of three different metals having one non-ferromagnetic metal and two ferromagnetic metals.

12. The metaconductor heterostructure material of claim 11, wherein the asymmetric structural arrangement has repeating trilayers.

13. The metaconductor heterostructure material of claim 1, wherein the layered design comprises an asymmetric structural arrangement consisting of four different metals having one non-ferromagnetic metal and three ferromagnetic metals having a quaternary metaconductor structure.

14. The metaconductor heterostructure material of claim 13, wherein the asymmetric structural arrangement has a grouping of four layers that repeat.

15. A wireless power transfer system comprising:
a transmitter antenna configured to transmit a radiative power signal;
a receiver antenna configured to capture the transmitted radiative power signal; and
a rectifier circuit coupled to the receiver antenna and configured to convert the captured radiative power to DC power;
wherein the transmitter antenna, the receiver antenna, and the rectifier circuit are each formed of a metaconductor heterostructure material having (a) a plurality of ferromagnetic metals within a layered design; and (b) a non-ferromagnetic metal included within the layered design.

16. The system of claim 15, wherein the layered design includes varying thickness ratios of the ferromagnetic metals.

17. The system of claim 15, wherein the layered design includes varying thermal conductivities for the ferromagnetic metals.

18. A method comprising:
incorporating multiple ferromagnetic metals with different thermal conductivities in a layered design of a metaconductor heterostructure material;
incorporating a non-ferromagnetic metal within the layered design of the metaconductor heterostructure material;
forming a transmitter antenna, a receiver antenna, and/or a rectifier circuit from the metaconductor heterostructure material; and
incorporating the transmitter antenna, the receiver antenna, and/or the rectifier circuit in a wireless power transfer system.

19. The method of claim 18, wherein different ones of the multiple ferromagnetic metals exhibit different ranges of negative permeability.

20. The method of claim 18, wherein the layered design includes varying thickness ratios of the ferromagnetic metals or the layered design includes varying thermal conductivities for the ferromagnetic metals.
